(19) United States
(12) Patent Application Publication
(10) Pub. No.: US 2005/0221163 A1
(43) Pub. Date: Oct. 6, 2005

(54) Nickel foam and felt-based anode for solid oxide fuel cells

(76) Inventors: Quanmin Yang, Mississauga (CA); Stephen Francis Corbin, Waterloo (CA); Vladimir Paserin, Mississauga (CA); Ryan Michael Christian Clemmer, Elmira (CA); Henry Huan Huang, Toronto (CA); Douglas Charles, Mississauga (CA)

Correspondence Address: INCO PATENTS & LICENSING, PARK 80 WEST - PLAZA TWO, SADDLE BROOK, NJ, 07663, US

(21) Appl. No.: 10/819,381

(22) Filed: Apr. 6, 2004

(51) Int. Cl. H01M 4/86; H01M 8/12; H01M 4/88; H01M 4/90; B05D 5/12

(52) U.S. Cl. 429/44; 429/30; 502/101; 427/115; 204/192.15; 205/560

(57) ABSTRACT

A solid oxide fuel cell anode is comprised of a nickel foam or nickel felt substrate. Ceramic material such as yttria stabilized zirconia or the like is entrained within the pores of the substrate. The resulting anode achieves excellent conductivity, strength and low coefficient of thermal expansion characteristics while effectively reducing the overall quantity of nickel contained in the fuel cell. Equivalent or better fuel cell anode characteristics result in the present invention as compared to conventional anode designs while simultaneously employing significantly less nickel.

### TECHNICAL FIELD

This invention relates to electrodes for solid oxide fuel cells (“SOFC”) in general and, more particularly, to nickel foam or nickel felt based-anodes for solid oxide fuel cells.

### BACKGROUND OF THE INVENTION

All fuel cells directly convert chemical energy into electrical energy by the ionization generating reaction between an oxidant gas and a fuel gas. Perceived as a more environmentally friendly alternative to current conventional sources of power, fuel cells have been the subject of increased promise, research and debate.

Solid oxide fuel cells are high temperature (750° C.-1000° C.) electrochemical devices that are primarily fabricated from oxide ceramics. SOFC's can operate with hydrogen or reformed hydrocarbons (carbon monoxide and hydrogen) and oxygen. In contrast, low temperature fuel cells, (60° C.-85° C.) (proton exchange membrane fuel cells—“PEMFC”) are limited to hydrogen or methanol and oxygen.

SOFC's consist of a gas permeable solid ceramic anode, a gas permeable solid ceramic cathode and a solid electrolyte disposed between the anode and the cathode.

The electrolyte is a dense ceramic layer—typically yttria stabilized zirconia (“YSZ”)—that functions as an electronic insulator, an oxygen ion conductor and a fuel and oxygen gas crossover barrier.

The cathode is usually an oxide doped for high electrical conductivity. It is typically made by sintering LaSrMnO₃ powder and YSZ powder to form a solid gas permeable composite.

The anode is a cermet typically made by sintering nickel powder or nickel oxide powder with YSZ powder. After sintering and reducing, the final form is a sintered porous structure with about 65% solids by volume and about 35% of which is nickel. The nickel and YSZ form a continuous, electrically conductive network for electron and ion transport, respectively.

Nickel is desirable since it imparts good electrical conductivity, corrosion resistance and strength to the anode. However, the cost of nickel, although a relatively low cost base metal, may be a factor in some SOFC designs.

Depending on the design, a SOFC may be anode supported, electrolyte supported or cathode supported. These components provide mechanical support to the cell assembly.

In a cathode or electrolyte supported SOFC, these respective components tend to be relatively thick thereby decreasing the efficacy of the SOFC and raising its costs.

In contrast, an anode supported SOFC has an approximately 0.5 mm-1 mm thick anode, an approximately 5-10 μm thick electrolyte layer and an approximately 50 μm thick cathode. Because an anode supported SOFC provides better performance, more robust construction, higher electrical conductivity (lower ohmic losses) and economy, it is often the preferred cell of choice.

A high efficiency anode requires a number of parameters—some working at cross purposes:

1) In order to increase conductivity, additional nickel is required.

2) In order to match the coefficient of thermal expansion (“CTE”) of the YSZ in the electrolyte, less nickel is required.

3) In order to achieve high gas permeability, high porosity is required.

4) In order to achieve increased anodic activity (that is, minimized polarization losses), high porosity is preferred.

High conductivity requires commensurately elevated nickel content and low porosity. Unfortunately nickel has a higher CTE than most of the other cell materials. Accordingly, elevated nickel content will increase CTE mismatch with potential cracking and discontinuities. On the other hand, low porosity reduces gas permeability which has a major impact on polarization losses.

Current commercially available anodes are comprised of nickel powders or nickel oxide powders of various morphologies sintered with YSZ powder to form the cermet. The conductivity of the cermet is a function of its nickel content and the geometry or morphology of the nickel in the cermet. Studies have shown that filamentary nickel powder, such as Inco® Type 255 (Inco is a trademark of Inco Limited, Toronto, Canada), results in superior anode performance over conventional spherical nickel or nickel oxide powders. (U.S. Pat. No. 6,248,468 B1 to Ruka et al.)

A state of the art anode has 35% porosity with 35% nickel as volume percentage of solids (nickel plus YSZ).

A challenge is to develop a nickel supported anode structure and process for manufacturing the anode that provides conductivity equal to or greater than that of the current technology with a significantly reduced nickel content while simultaneously providing desirably high porosity in the electrode.

### SUMMARY OF THE INVENTION

There is provided an SOFC anode including nickel foam or felt as the porous metal substrate and an entrained ceramic network for oxygen ion conduction. YSZ or a similarly acting component is introduced into the nickel foam or felt substrate via a carrier resulting in desirably high electrical conductivity with a suitable CTE while simultaneously reducing the quantity of nickel contained therein.

### BRIEF DESCRIPTION OF THE DRAWINGS

FIG. 1 is a graph plotting conductivity vs. volume of nickel.

FIG. 2 is a graph plotting conductivity vs. volume of nickel.

FIG. 3 is a comparison graph plotting conductivity vs. bulk nickel volume before and after sintering, reduction and compression.

FIG. 4 is a graph plotting dimensional change vs. temperature.

FIG. 5 is a graph plotting coefficient of thermal expansion vs. temperature.

FIG. 6 is a graph plotting coefficient of thermal expansion vs. nickel volume percentage.

FIG. 7 is a photomicrograph of an embodiment of the invention.

FIG. 8 is a photomicrograph of an embodiment of the invention.

FIG. 9 is a photomicrograph of an embodiment of the invention.

FIG. 10 is a photomicrograph of an embodiment of the invention.

### PREFERRED EMBODIMENTS OF THE INVENTION

As noted previously, current SOFC anode technology uses Ni or NiO powders of various morphologies for sintering with the YSZ powder to form the cermet electrode. The conductivity of the cermet is determined by its nickel content and the geometry or morphology of the nickel in the cermet. Filamentary nickel powder and nickel coated graphite appear to provide improved anode performance over spherical Ni or NiO powders in conventional sintered anode designs.

In a composite containing nickel, there is a percolation threshold volume fraction for nickel to form a conductive network to make the composite conductive. Above the percolation threshold, as per a model developed by D. McLachlan, M. Blaszkiewicz and R. Newnham, J. Am. Ceram. Soc. 73 (1990), page 2187, (“MBN” model), the conductivity due to nickel in the composite may be calculated by:

$${σ}_{c} = {{σ}_{Ni} ( \frac{{V}_{Ni} - {V}_{c}}{1 - {V}_{c}} )}^{t}$$

where:
σ_{c}=composite conductivity
σ_{Ni}=Ni conductivity
V_{Ni}=Ni volume fraction (including porosity)
V_{c}=Ni percolation volume fraction
t=microstructure parameter

To calculate the upper level of conductivity (the upper bound model—“UBM”), this value can be obtained from the MBN model assuming V_{c}=0 and that nickel has a one-dimension structure like nickel wires and that the wires are parallel with the direction of current in conductivity measurement.
σ_{c}=V_{Ni}σ_{Ni}

A typical battery type nickel foam has a uniform three-dimension cell structure and the above model cannot be applied. The nickel strands that are not in the direction of current flow contribute very little to the conductivity in that direction. If the low density nickel foam is simplified as a three-dimensional square mesh grid, made up of individual cubic cells, only one third of all the nickel strands are in the current flow direction and contribute to the measured conductivity in that direction. At high porosity or low nickel density, a modified upper bound model (“MUBM”) for high porosity nickel foam is suggested to reflect the above consideration:
σ_{c}=V_{Ni}/3×σ_{Ni}

The conductivity predicted by this model can be considered as the highest conductivity achieved by a three-dimensional porous structure at the high porosity end.

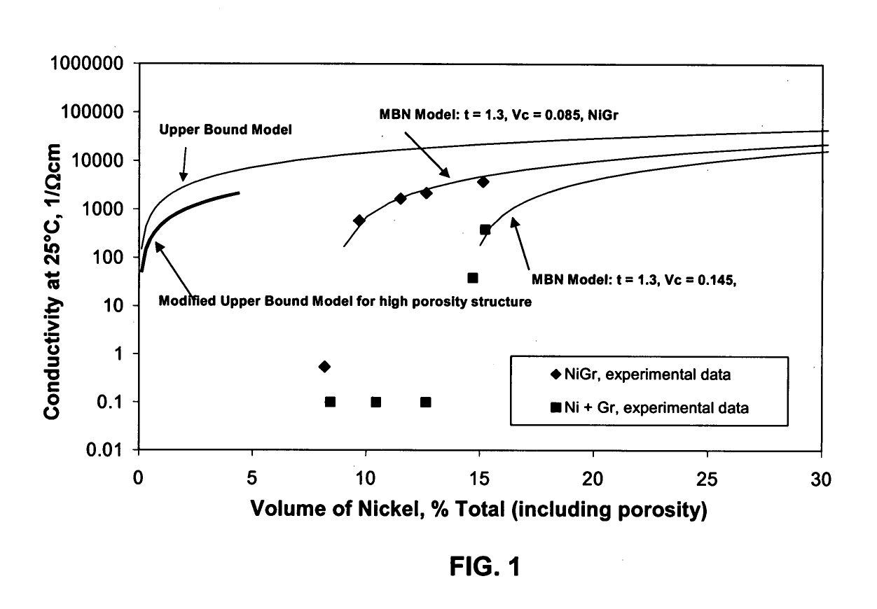

FIG. 1 depicts calculated theoretical conductivity values of the upper bound model and the modified upper bound model for high porosity structures having YSZ powder against volume of nickel, percentage total at room temperature. For comparison purposes a number of conventional sintered anode designs—nickel coated graphite (“NiGr”) and nickel powder plus graphite powder (“Ni+Gr”) are shown.

From FIG. 1, significant potential exists for improvement in conductivity compared to the modified upper bound limit. It is known that nickel foam has good conductivity and is widely used in the battery industry as a conductive current collector.

As demonstrated by the ensuing experimental data, by using nickel foam in the anode of a SOFC, better conductivity results and/or reduced nickel content is required for a specified conductivity.

Nickel foam is highly porous, open-cell, metallic structure based on the structure of open-cell polymer foams. To produce nickel foam, nickel metal is coated onto open-cell polymer substrates such as polyurethane foam and sintered afterwards to remove the polymer substrate in a controlled atmosphere at high temperature. In general, a nickel coating can be applied by a variety of processes such as sputtering, electroplating and chemical vapor deposition (CVD). For mass production of continuous foam, electroplating and CVD are the main processes in the industry. The production process at Inco Limited (assignee) is based on either CVD of nickel tetracarbonyl (Ni(CO)₄) or by nickel electroplating on to an open-cell polyurethane substrate.

The term “about” before a series of values, unless otherwise indicated, is interpreted as applying to each value in the series.

Table 1 lists the conductivity of nickel foams produced by Inco Limited using proprietary nickel carbonyl gas deposition technology (U.S. Pat. No. 4,957,543 to Babjak et al.). Calculated values based on the modified upper bound model are also shown and compared in the table. It is apparent that the conductivity of nickel foams corresponds very well to the predicted values, indicating the nickel foam structure provides superior conductivity. This is attributed to its unique cell or pore structure inherited from raw polyurethane foam on which nickel is plated and is not matched by any other currently sintered porous structure starting from powder materials.

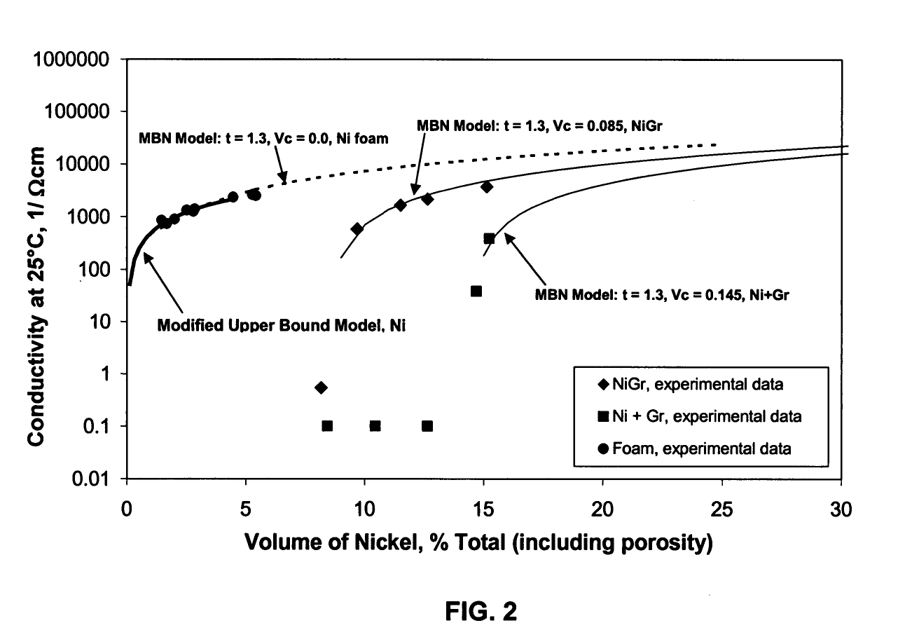

In current technology, if Ni powder or NiO powder, regardless of their morphology, e.g. spherical Inco® Type 123 Ni powder and green NiO powder, or filamentary Inco® Type 255 powder (U.S. Pat. No. 4,971,830 to Jenson et al; U.S. Pat. No. 6,248,468 B1 to Ruka et al) or other alloy powder (U.S. 2003/0059668 A1 to Visco et al) are used in sintering with YSZ to make anodes of SOFC, some nickel will be isolated in the YSZ and some dead ends will exist in the sintered structure. These isolated nickel particles or dead ends will not contribute to the conductivity of the anode. Before a conductive network is formed, i.e. before reaching the so-called percolation threshold V_{c}, all nickel particles in the anode contribute little to the conductivity. V_{c} is a good indication on how much nickel is not contributing to anode conductivity. The conductivities of nickel foams in Table 1 are also calculated using the MBN model setting V_{c} to zero. It is seen that the experimental data coincide with predicted values. This shows that virtually all the nickel in nickel foam contributes to conductivity. The experimental data measured at room temperature and predicted values of nickel foam are shown in FIG. 2. The values of nickel foam compare favorably with the theoretical curves and are superior to the prior art sintered anode curves in FIG. 1.

TABLE 1
Conductivity of Ni foams produced by Inco's Ni
carbonyl gas deposition process and calculated
values based on modified upper bound model.

| | | Calculated | Calculated |
|---|---|---|---|
| Ni | Measured | conductivity, modified | conductivity, MBN |
| density | conductivity, | upper bound model | model V_{c} = 0.0, |
| Vol % | 1/cmΩ | 1/cmΩ | t = 1.3, 1/cmΩ |
| 1.45 | 856 | 706.6 | 595.3 |
| 1.57 | 756.1 | 765.1 | 660.1 |
| 1.67 | 730.7 | 813.8 | 715.3 |
| 1.99 | 898 | 969.8 | 898.4 |
| 2.5 | 1328.5 | 1218.3 | 1208.6 |
| 2.78 | 1265.7 | 1354.8 | 1387.4 |
| 2.84 | 1394.4 | 1384.0 | 1426.5 |
| 4.46 | 2352.4 | 2173.5 | 2565.0 |
| 5.26 | 2624 | 2563.4 | 3178.5 |
| 5.41 | 2525.2 | 2636.5 | 3296.9 |

It is seen from FIG. 2 that similar conductivity was achieved in nickel foam at a fraction of nickel content as found in the current SOFC sintered technology using nickel powder or nickel coated graphite (NiGr). This is a significant improvement never achieved by any SOFC developer using any other technologies.

Similar to nickel foam, nickel felt may provide similar conductivity and may also be used as the porous metal substrate of the anode.

Nickel felt is a highly porous, filamentary metallic structure based on the structure of polymer felts. To produce nickel felt, nickel metal is coated onto felted polymer substrates such as polyester felt and sintered afterwards to remove the polymer substrate in a controlled atmosphere at high temperature. In general, nickel coating can be applied by a variety of processes such as sputtering, electroplating and chemical vapor deposition.

The following discussion relates to a preferred method of making SOFC anodes using nickel foam or nickel felt as the substrate. Although YSZ is the standard electrolyte other ceramic electrolytes are suitable.

A carrier such as a slurry containing YSZ powder, foaming agents, organic binders, or other additives can be pasted and entrained into the pores of nickel foam or nickel felt and then dried. The Ni/YSZ ratio can be well controlled by the solids content in the slurry and also by adjusting the nickel foam or nickel felt thickness before pasting. After pasting and drying, the coupon can be compressed to any targeted porosity.

The dried green coupon consisting of nickel foam or nickel felt and YSZ and other additives may be made into a final anode by various steps. A burn-off step may be required if organics, graphite, or other pore forming agents are used. Following the burn-off step, sintering at an appropriate temperature is needed to form a continuous YSZ network. The sintering can be conducted in a traditional sintering process as for a conventional anode made from Ni/NiO powder and YSZ powder at high temperature, such as 1475° C. in air. A reduction step may follow the sintering and be completed at a temperature lower than the melting point of nickel in a reducing atmosphere. Another attribute of the invention is that the sintering and reduction steps may be combined in one step. Both sintering and reduction may be accomplished in a reducing atmosphere at a temperature below the melting point of nickel. In this case no separate sintering step is required and the structure and therefore the conductivity of the nickel foam or felt will be retained. The recipe and the viscosity of the slurry can be controlled to produce desired porosity in the final anode.

Potential benefits of using nickel foam or nickel felt as the substrate of an anode and employing pasting process to make final anode electrodes of SOFCs are as follows:

(1) The required nickel content for the requisite conductivity can be reduced dramatically by using nickel foam or nickel felt to replace conventional sintered nickel structures in the anode.

(2) Such a physical reduction in nickel content will extend the operation and thermal cycling life of the SOFC due to a better CTE match between the cell components.

(3) In addition, the porosity of the electrode will easily be controlled by the solids fraction in the slurry of the YSZ powder because the electrode volume is pre-determined by the foam or felt porosity. Further control over the final porosity can be achieved by pressing to various desired densities. This avoids the use of a pore forming agent like graphite to create large pores.

(4) On the other hand, the slurry pasted into the foam or felt can also contain pore forming agents and/or nickel powders and/or particles. This allows a wide flexibility over the structure of the anode, creating macro- and micro-porosity and a range of different nickel morphologies to enhance or selectively fine tune electrochemical performance.

(5) The YSZ loading may be varied across the anode thickness by the selected pasting procedure. The side in contact with electrolyte side may be pasted twice to increase the loading.

(6) In addition, both nickel foam or felt manufacturing and the pasting process are established technologies in the battery industry and provide a low cost mass production method for SOFC anodes, a critical factor in the commercialization of anode supported SOFC's.

(7) The nickel foam or felt have volume fractions of nickel from about 1% to 30% or above of the anode, preferably in the range of about 3% to 15%, and more preferably in the range of about 5% to 10%.

(8) Cell or pore size of the nickel foam or felt is in the range of about 10 μm to 2 mm, and preferably in the range of about 50 μm to 0.5 mm.

(9) The specific surface area of the nickel foam or felt can be modified using nickel and other powder coating and bonding techniques.

(10) Although preferably made by carbonyl techniques, the nickel foam or felt may also be produced by chemical vapor deposition, electroplating, sputtering, directed vapor deposition, sintering or any other methods on polymer materials or other materials that have established pore structure and porosity.

(11) The nickel foam or felt can be modified at its surface or in bulk by other metals for reasons such as selected mechanical properties, corrosion resistance, or enhanced surface area.

(12) The paste slurry may also contain Ni, NiO powders or other metallic additives, pore forming agents and binder materials, in addition to the principal electrolyte component such as YSZ.

A number of examples attest to the efficacy of the invention.

### EXAMPLE 1

### Pasting, Drying, and Compression Process

The nickel foam used in this example was produced by Inco Limited at its Clydach nickel refinery in Wales, UK using metal carbonyl technology. The density of this foam has a nominal value measured as 600 g/m². The nominal thickness of the nickel foam is 1.9 mm. The foam was cut to 5 cm by 6 cm coupons. The first coupon was pre-compressed to 0.98 mm, and the second and third coupons were slightly compressed to 1.80 mm and 1.74 mm, respectively. The nominal nickel volume fraction in the original foam is 3.5%. In the pre-compressed coupons, the nickel volume fraction is 3.7%, 3.9%, and 6.6% for coupons of 1.80 mm, 1.74 mm, and 0.98 mm thick, respectively. Nickel foam can be made by carbonyl technology with initial nickel volume fraction from about 1.5% to 30% or higher and it can also easily be adjusted by any compression process as noted above.

Preparation of Anodes #1˜6:

Slurry containing 30 g YSZ powder, 15 g 1.173/wt % polyvinyl alcohol (“PVA”) solution in water and ethanol (1:1 weight ratio) was prepared by adding the YSZ powder into the PVA solution and mixed with a propeller mixer for five minutes. The slurry was pasted into the above nickel foam coupons using a spatula. After cleaning the surface to remove the excessive paste, the coupons were dried in a forced air oven at 60° C. for 45 minutes. The weight of the YSZ and PVA was determined by weighing the dried coupon and subtracting the nickel foam weight. Using a density of 6.1 g/cc for YSZ and 8.9 g/cc for Ni, the target thickness of the coupon can be determined according to desired final porosity. The coupons are compressed through a roller press with gaps pre-set to different sizes. Table 2 shows the properties of initial foam and the final anode properties before sintering.

In Table 2 and following examples, the following terms are used regarding nickel densities. The term “bulk volume %” refers to the percentage of the total anode volume which is occupied by the Ni (or the YSZ), whereas term “volume as % solids” refers to the percentage of the total volume represented by solids (i.e. the YSZ plus Ni) which is occupied by the Ni (or the YSZ). Therefore “bulk volume %” measurement includes the porosity of the samples while the “volume as % solids” measurement does not.

It is seen from Table 2 that Ni/YSZ ratio can be adjusted by using nickel foam of different thicknesses. Anodes #1˜3 were made by using 0.98 mm thick foam and had Ni/YSZ ratio of 23%/77%=0.30, while anodes #46 were made by 1.80 mm thick foam and had Ni/YSZ ratio 0.16. By compressing to different target thickness, various porosities of a pasted coupon were achieved, as demonstrated by anodes #1˜6.

Preparation of Anodes #7˜9:

The same procedure was used to prepare anodes #7˜9, except Inco® Type 255 filamentary Ni powder was added in the slurry. In these anodes nickel is distributed in two forms, i.e. nickel foam and nickel powder. Other nickel additives such as nickel flakes, nickel fibers, nickel coated graphite, etc. and pore forming agents can also be added in slurry to adjust nickel distribution and to form different pore structures.

Comparing anodes #7˜9 and anodes #1˜3, it is seen that, although they have different nickel distributions and similar Ni/YSZ ratios, similar porosity can be reached by controlling initial nickel foam thickness prior to pasting.

TABLE 2
Pasted SOFC anode using nickel foam.

| | | Ni | Ni | | Ni | | Target | Bulk | | | | |
|---|---|---|---|---|---|---|---|---|---|---|---|---|
| | Ni Foam | Foam | Foam | YSZ | powder | PVA | anode | Ni | Ni | YSZ | Anode | |
| Paste | thickness | Area | wt | wt | wt | wt | thickness | Vol % | Vol % of | Vol % of | Porosity | Anode |
| components | mm | cm² | gram | gram | gram | gram | mm | % | solids % | solids % | % | # |
| YSZ + PVA | 0.98 | 30 | 1.72 | 4.01 | N/A | 0.0235 | 0.98 | 6.6 | 23 | 77 | 71 | 1 |
| | | | | | | | 0.71 | 9.1 | 23 | 77 | 60 | 2 |
| | | | | | | | 0.42 | 15.3 | 23 | 77 | 32 | 3 |
| YSZ + PVA | 1.80 | 30 | 1.78 | 7.44 | N/A | 0.0436 | 1.80 | 3.7 | 14 | 86 | 74 | 4 |
| | | | | | | | 1.18 | 5.6 | 14 | 86 | 60 | 5 |
| | | | | | | | 0.70 | 9.5 | 14 | 86 | 32 | 6 |
| YSZ + PVA + Ni | 1.74 | 31 | 1.86 | 6.59 | 1.16 | 0.0454 | 1.74 | 6.2 | 24 | 76 | 74 | 7 |
| powder | | | | | | | 1.18 | 9.2 | 24 | 76 | 61 | 8 |
| | | | | | | | 0.70 | 15.5 | 24 | 76 | 35 | 9 |

### EXAMPLE 2

### Conductivity of SOFC Anode Using Nickel Foam

The nickel foam used in this example was produced at Inco Limited at its Clydach nickel refinery in Wales, UK using metal carbonyl technology. The density of this foam has a nominal value measured as 1360 g/m². Samples with a size of 20 mm by 10 mm with an average thickness of 2.46 mm were cut from large sheets of the nickel foam and weighed. These samples were used to prepare the foam-based Ni/YSZ composites and to measure electrical conductivity. Some cut foam pieces were not pasted with YSZ so that comparative conductivity measurements could be made. A selection of the cut foam pieces were placed in a small container that contained 8 mole % Y₂O₃ stabilized ZrO₂ (YSZ) ceramic powder in an alcohol suspension. The foam was soaked in this thick powder suspension for 1 to 2 minutes, removed and allowed to air dry for 1 to 2 minutes. After drying, the excess YSZ powder on the surface of the foam was removed and the sample weighed.

Four of the pasted foams were placed within a steel die with dimensions close to 20×10 mm and pressed together under a pressure of 15,000 lb_{f} (66,720 N) using a manually controlled hydraulic press. For comparison purposes this pressing operation was also performed on four unpasted nickel foams but using a lower pressure of 5,000 lb_{f} (22,240 N). Table 3 gives some example dimensions of the pasted foam before and after pressing. The length and width of the samples increase slightly as the samples deform toward the die wall cavity which is slightly larger than the cut sample dimensions. A significant reduction in the sample thickness occurs during pressing which accounts for most of the increased density of the samples. Tables 4 and 5 give important physical measurements obtained from the samples before and after pressing. The terms “bulk volume %” and “volume as % solids” have the same meaning as that of Example 1. Table 4 indicates that the pressing operation increases the bulk volume of the Ni (or YSZ) by a factor of 2 while reducing the porosity by the same factor.

Samples of pasted and unpasted foam, in both the unpressed and pressed conditions, were then heated in an air atmosphere up to 1475° C., held at this temperature for two hours, and then cooled to room temperature. The purpose of this step was to sinter the YSZ powder into a dense continuous network within the composite anode.

Before conductivity testing was performed, the sintered samples were heated in a 95% N₂/5% H₂ gas atmosphere up to 950° C., held at this temperature for four hours and then cooled to room temperature. The purpose of this step was to convert the NiO, formed during high temperature sintering in air, back to elemental nickel.

Electrical conductivity of the samples was measured by a standard two-point probe technique. A constant current of 1 amp was passed through the samples of known cross section and the voltage drop between two points was measured. Conductivity was then calculated using the following formula;

$$σ = \frac{I * L}{A * V}$$

where σ is the sample electrical conductivity in 1/(Ohms.cm), I is the current in amps, L is the length in cm over which the voltage drop is measured, V is the voltage drop in volts and A is the cross sectional area of the sample in cm².

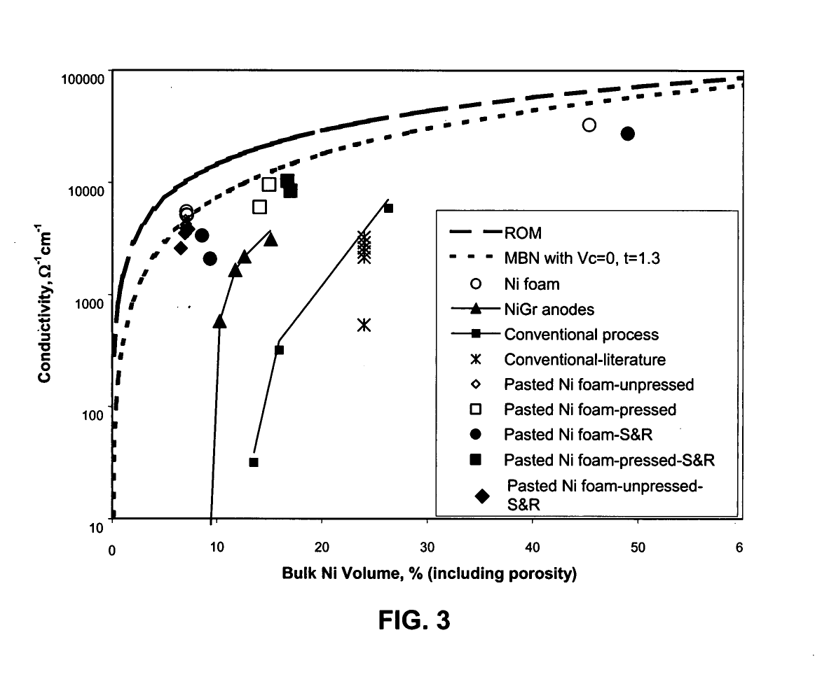

In order to determine the influence of each processing step on conductivity, electrical conductivity of the as-cut foam, the pressed but unpasted foam, the pasted foam, and the pasted and pressed foam was measured. In addition the conductivity of all of these samples before and after sintering/reduction was measured. The results of all these experiments are in FIG. 3.

FIG. 3 illustrates the results where conductivity is plotted as a function of the bulk nickel volume %. The first point to note is that the YSZ pasting process itself does not alter the conductivity of the material. Therefore pasting creates a Ni/YSZ porous composite with a conductivity equivalent to the nickel foam used as the substrate. Secondly, pressing increases the conductivity of the sample primarily due to a reduction in porosity and an increase in the bulk nickel volume. The presence of YSZ within the paste resists deformation during pressing such that the bulk volume of nickel increases to about 15%. In the absence of YSZ, the nickel foam densifies to about 45% and this in turn results in a much higher conductivity.

Open and solid symbols in FIG. 3 indicate conductivity values before and after sintering/reduction, respectively.

Also included in FIG. 3 are previous results from anodes made from Ni-coated graphite (NiGr), by conventional anode processes based on separate Ni and YSZ powders and published data from the literature for conventional anode materials. Clearly the YSZ pasted nickel foams have superior conductivity data compared to all of these previous anode materials. A calculation based on a rule of mixtures (“ROM”) is also included in FIG. 3. This is known as an upper bound prediction such that, for a given bulk nickel content, it represents the highest possible conductivity that can be obtained in a composite sample. Clearly the nickel foam samples approach the closest to this upper bound.

Also included in FIG. 3 is conductivity data for the foam materials after sintering/reduction (“S&R”). The most important observation from this data is that the conductivity of the “pasted and pressed” samples actually increases after sintering and reduction. This is due to the small reduction in volume (and therefore increase in nickel bulk volume) that occurs during sintering. In the case of unpressed pasted foams and the pure nickel foams, conductivity decreases slightly. This is due to incomplete reduction of these samples. The more open structure of the unpressed materials led to more extensive oxidation of the nickel during sintering. This meant that these samples were not completely reduced back to nickel using the reduction step employed. In the pressed materials oxidation of the nickel was much less extensive due to the lower porosity and protective action of the YSZ. In this case the subsequent reduction step was capable of complete conversion of NiO to its elemental form.

TABLE 3
An example of the dimensions of pasted
Ni foams before and after pressing.

| Sample | Length (mm) | Width (mm) | Thickness (mm) |
|---|---|---|---|
| Unpressed (4 layers) | 20.08 | 10.53 | 9.83 |
| Pressed (4 layers) | 22.41 | 13.49 | 3.41 |

TABLE 4
Measurements of anode composites produced by the soaking
pasting method and used for conductivity measurements.

| | | Ni | YSZ | | Bulk | Bulk |
|---|---|---|---|---|---|---|
| Sam- | | Vol. % | Vol. % | Poros- | YSZ | Ni |
| ple | # of layers | solids* | solids* | ity % | Vol. %* | Vol. % |
| 1 | Single/unpressed | 23.0 | 77.0 | 70 | 22.8 | 6.8 |
| 2 | Single/unpressed | 24.9 | 75.1 | 71.2 | 21.6 | 7.2 |
| 3 | Single/unpressed | 24.8 | 75.2 | 71.3 | 21.6 | 7.1 |
| 4 | Single/unpressed | 24.9 | 75.1 | 71.6 | 21.3 | 7.1 |
| 5 | Single/unpressed | 23.5 | 76.5 | 70.3 | 22.7 | 7.0 |
| 6 | Single/unpressed | 22.4 | 77.6 | 68.8 | 24.2 | 7.0 |
| 7 | Single/unpressed | 22.7 | 77.3 | 69.7 | 23.4 | 6.9 |
| 8 | 4/pressed | 23.4 | 76.6 | 39.8 | 46.1 | 14.1 |
| 9 | 4/pressed | 23.7 | 76.3 | 36.8 | 48.2 | 14.9 |

*These values were estimated based on the weight gain of the foam after pasting of the YSZ slurry.

TABLE 5
Measurements of Ni foam before and after pressing
and used to measure conductivity.

| | | Ni | YSZ | | Bulk | Bulk |
|---|---|---|---|---|---|---|
| Sam- | | Vol. % | Vol. % | Poros- | YSZ | Ni |
| ple | # of layers | solids | solids | ity % | Vol. % | Vol. % |
| 1 | Single/unpressed | 100 | 0 | 92.9 | 0 | 7.1 |
| 2 | Single/unpressed | 100 | 0 | 92.9 | 0 | 7.1 |
| 3 | Single/unpressed | 100 | 0 | 92.9 | 0 | 7.1 |
| 4 | 4/pressed | 100 | 0 | 54.7 | 0 | 45.3 |

### EXAMPLE 3

### Coefficient of Thermal Expansion of SOFC Anodes Made Using Nickel Foam

The nickel foam used in this example was produced by Inco Limited at its Clydach nickel refinery in Wales, UK using metal carbonyl technology. The density of this foam has a nominal value measured as 1360 g/m². Samples with a size of 8 mm by 6 mm with an average thickness of 2.46 mm were cut from large sheets of the nickel foam and weighed. These samples were used to prepare the foam-based Ni/YSZ/composites and to measure the coefficient of thermal expansion. A selection of the cut foam pieces were placed in a small container and 8 mole % Y₂O₃ stabilized ZrO₂ (YSZ) ceramic powder placed on top of the foam. This powder was then washed into the internal foam structure using alcohol. Once a sufficient amount of YSZ was washed into the foam (approximately 65 vol % on a solids basis) samples were removed from the container and air dried for 1 to 2 minutes. After drying, samples were weighed.

Four of these pasted foams were placed within a steel die with dimensions close to 8×6 mm and pressed together under a pressure of 5,000 lb_{f} (22,240 N) using a manually controlled hydraulic press. Table 6 gives important physical measurements obtained from the sample before and after pressing. The terms “bulk volume %” and “volume as % solids” have the same meaning as that of Examples 1 and 2. Table 6 indicates that the pressing operation increases the bulk volume of the Ni (or YSZ) and decreases the porosity by a similar factor to that observed in Example 2.

Samples of pasted and pressed foams were then heated in an air atmosphere up to 1475° C. held at this temperature for two hours and then cooled to room temperature. Before CTE measurements were performed, the sintered samples were heated in a reducing 95% N₂/5% H₂ gas atmosphere up to 950° C., held at this temperature for four hours and then cooled to room temperature.

These reduced samples were placed in a dilatometer and their dimensional changes up to 950° C. were monitored in the direction of their 8 mm dimension. These experiments were carried out in a 5% H₂/95% N₂ atmosphere. More than one heating cycle was required to achieve a stable sample dimension and accurate CTE measurement. This was due to the sample seating with the sample fixture. However a permanent length change in the sample dimensions (particularly after the first run) indicated that some sintering and or further reduction of oxidized nickel, which remained in the sample after the reduction step, was occurring. For the pressed samples, heating cycles were repeated until no hysteresis (or permanent size reduction) was evident from the dilatometer trace. CTE measurements were taken from the last heating curve. However in the case of the unpressed samples shrinkage in the form of hysteresis remained in the samples. In this case heating cycles were repeated until a constant dimensional change during heating was achieved. Again CTE measurements were taken from the last heating cycle.

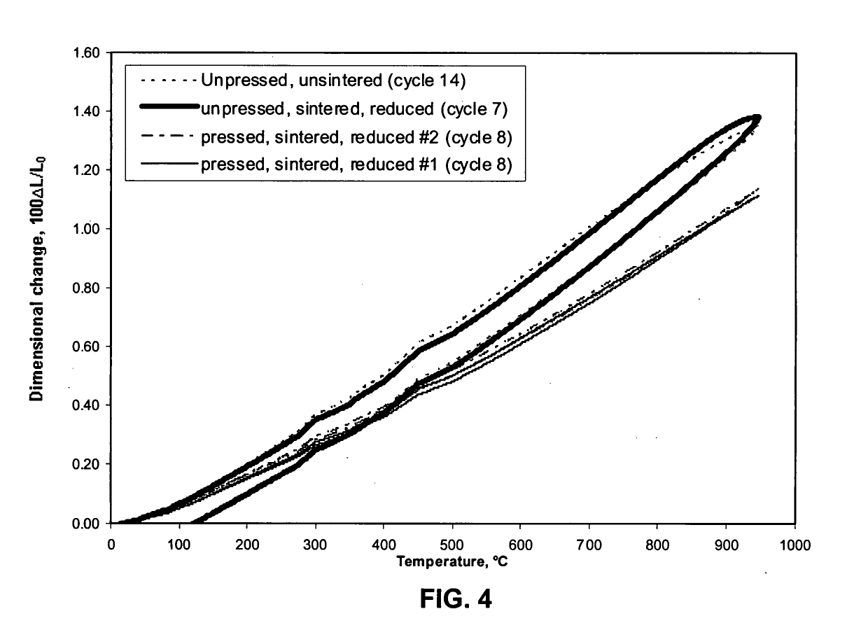

FIG. 4 indicates the dilatometer trace from the last heating cycle for the four pressed and unpressed samples of Table 6. The slope of these curves clearly indicates that the pressed samples have a lower CTE than the unpressed samples. Also indicated in FIG. 4 are the number of heating cycles used for each sample. The unpressed and unsintered sample No. 1 (simple dashed line) was very dimensionally unstable and continued to shrink even after 14 cycles. However after these numbers of cycles the slope of the heating curve did become repeatable such that accurate CTE measurements could be made. Note also that shrinkage, resulting in a hysteresis loop, only begins above 900° C. The unpressed but sintered & reduced sample No. 2 (heavy solid line) reached a stable slope at only 7 cycles although some shrinkage still occurs above 900° C. Therefore sintering does increase the dimensional stability in the unpressed state.

In contrast the pressed samples Nos. 3 and 4 as shown on FIG. 4 (sequentially dashed and thick solid lines, respectively) became much more dimensionally stable with no hysteresis and no indication of permanent shrinkage due to sintering up to 950° C. Therefore both the lower CTE and more stable dimensions of the pressed samples indicate that a continuous network of well sintered YSZ is achieved by the pressing operation.

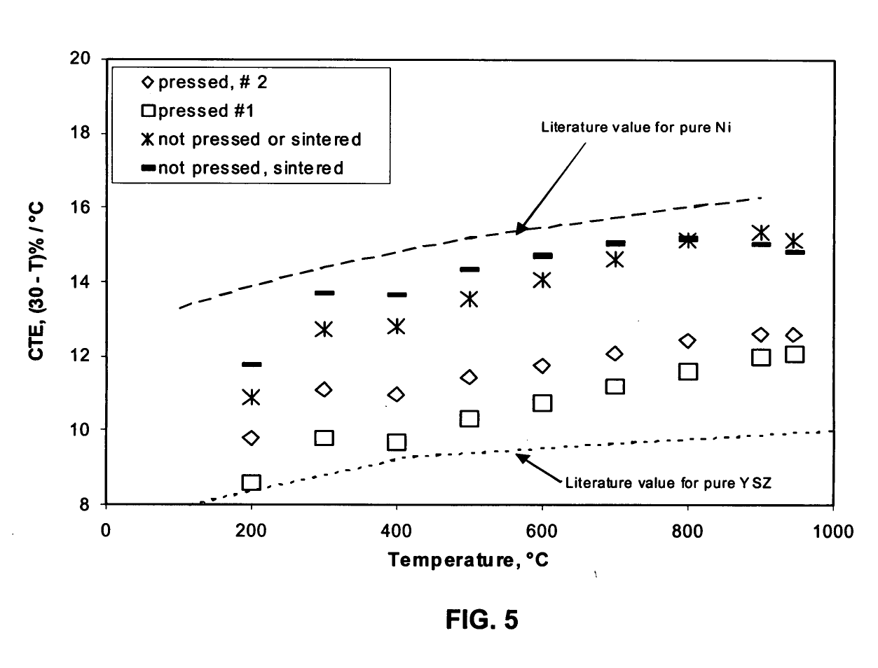

FIG. 5 indicates the technical alpha (or CTE) for various temperatures from 30° C. to 1000° C. Included for comparison are literature values for pure Ni and YSZ as well. Without pressing (and regardless of sintering or not) the CTE of the washed or pasted foam composites are similar to that expected of a pure nickel sample. Comparatively the “washed & pressed” foam composites have a significantly lower CTE. This is expected to be due to the higher bulk volume of YSZ (i.e. about 31%) produced due to pressing. This creates a continuous network of YSZ which becomes well sintered during high temperature firing. This results in a larger constraining effect on the continuous nickel structure produced by the foam and therefore a reduced CTE.

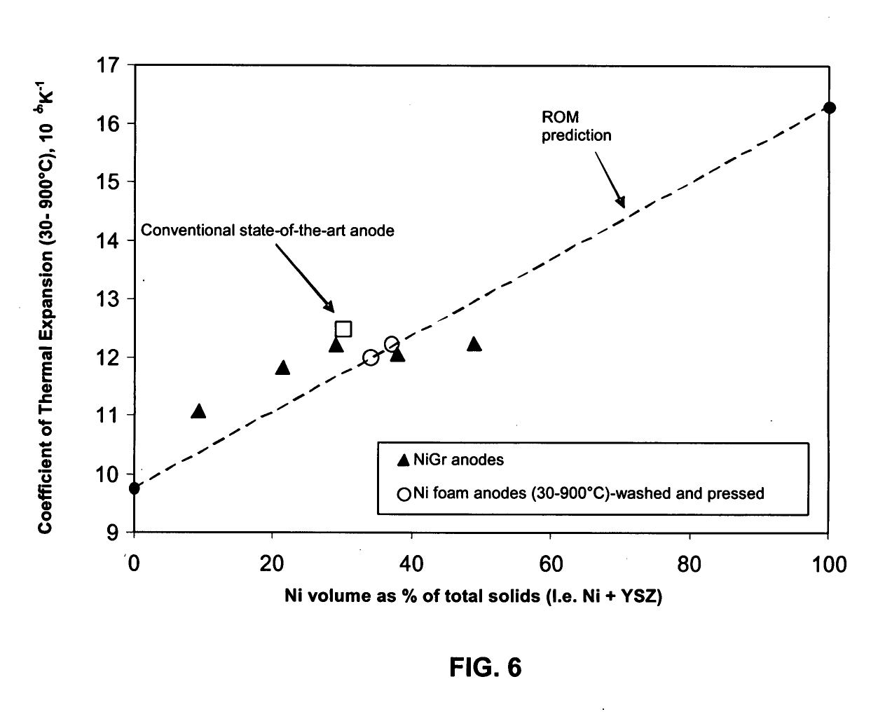

FIG. 6 plots the technical CTE value from 30-900° C. for the pressed materials of Table 6 as well as previous published results for composites made with Ni-coated graphite (NiGr) and with literature data for a state-of-the-art anode. The pressed data agrees very well with a ROM prediction and is similar to that achieved for composites made with nickel-coated graphite particles. Most importantly the CTE of the pressed composites is lower than that reported for conventional anode materials.

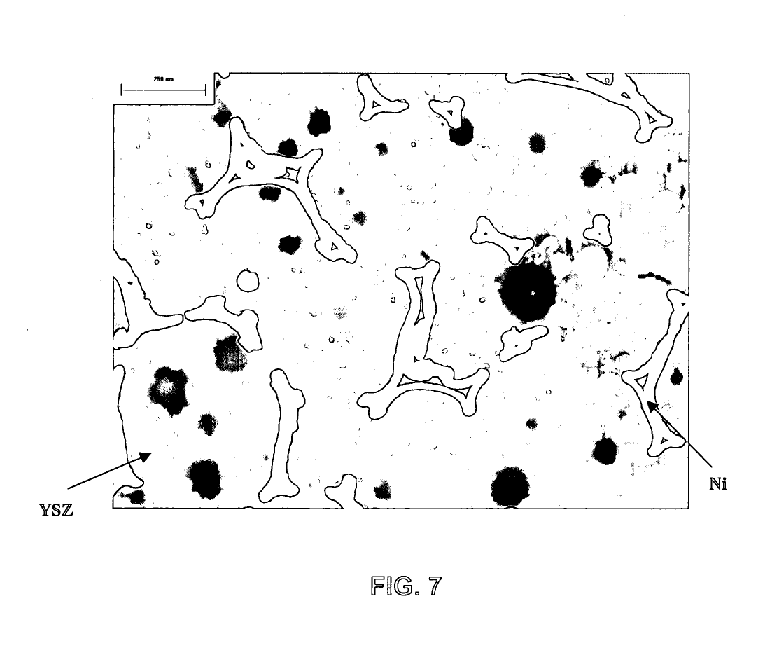

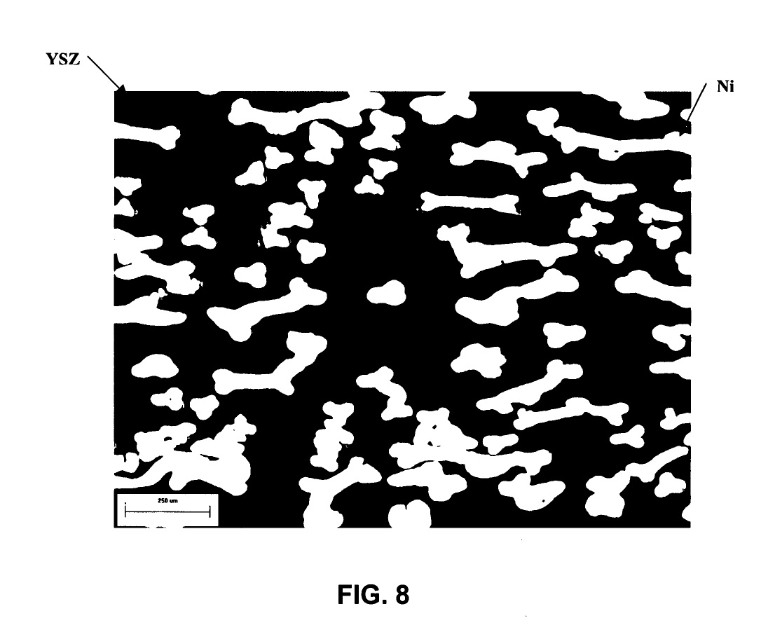

FIGS. 7 and 8 indicate the microstructure of the washed and “washed & pressed” samples of Table 6 before sintering and reduction, respectively. The agglomerates of YSZ are clearly visible in the unpressed sample, with considerable void space in between the agglomerates. The YSZ is well dispersed within the cells of the nickel foam. However direct contact between the YSZ and Ni is limited. Pressing collapses the nickel pores onto the YSZ and also consolidates the YSZ agglomerates into a single continuous YSZ phase. There are elongated voids perpendicular to the pressing direction. Pressing dramatically increases the contact between the Ni and YSZ which is required as part of the triple point boundary for fuel cell performance.

TABLE 6
Volume ratios, porosity and bulk volumes of Ni and YSZ produced
by the “washing” pasting and “washing & pressing” method
and used for CTE measurements.

| | | Ni | YSZ | | Bulk | Bulk |
|---|---|---|---|---|---|---|
| Sam- | | Vol. % | Vol. % | Poros- | YSZ | Ni |
| ple | # of layers | solids* | solids* | ity % | Vol. %* | Vol. % |
| 1 | Single/unpressed | 30 | 70 | 79 | 15.8 | 6.8 |
| 2 | Single/unpressed | 32 | 68 | 81 | 14.5 | 7.0 |
| 3 | 4/pressed | 34 | 66 | 52 | 31 | 16 |
| 4 | 4/pressed | 37 | 63 | 56 | 28 | 16 |

*These values were estimated based on the weight gain of the foam after pasting of the YSZ slurry.

In a conventional sintered anode, the continuous porous nickel structure in the anode is formed by sintering Ni or NiO powders with YSZ powder. In the present process, the continuous porous nickel structure, i.e. nickel foam or felt, is formed prior to the sintering process with YSZ by plating nickel on a porous polymer or other material substrate with established and desired pore structure.

The resulting anode consists of ceramic network that may be a composite having a ceramic component and a metallic component. The metallic component may be selected from nickel, copper, or any other appropriate metals or alloys whereas the ceramic component may be selected from YSZ, gadolinium doped cerium oxides or any other oxygen conducting ceramic materials.

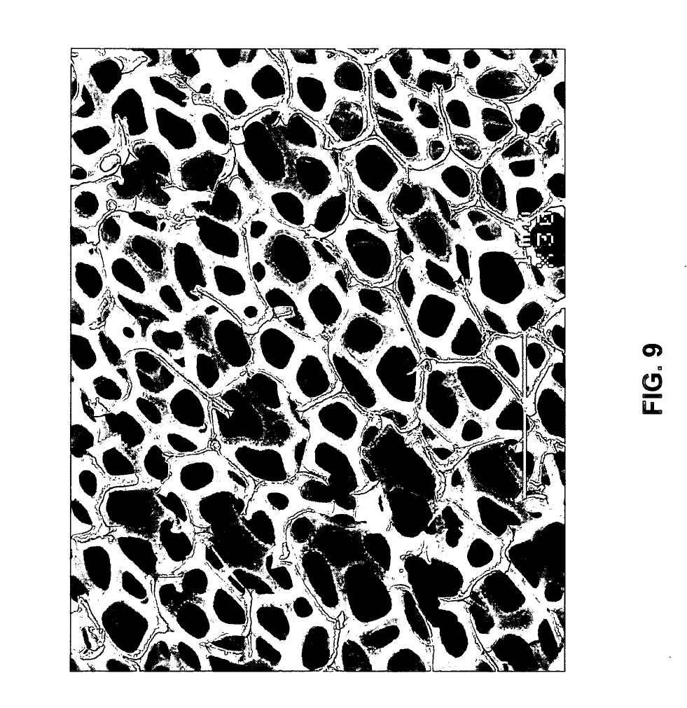

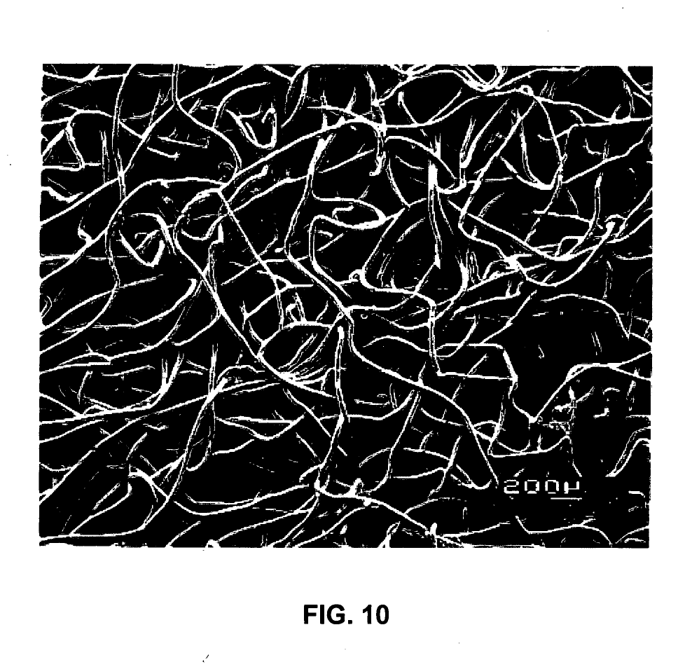

Nickel foam or nickel felt has inherently the highest conductivity, with a percolation volume of zero, due to its unique cell (pore) structure. Its conductivity cannot be matched by any known sintered structure starting from metal powder materials, regardless the morphology, e.g. spherical or filamentary. A surface photomicrograph of nickel foam is shown in FIG. 9 and a surface photomicrograph of nickel felt is shown in FIG. 10.

As opposed to conventional sintered anodes which essentially consist of a random linkage of sintered nickel particles, the present porous metal substrate forms the physical platform or backbone of the anode providing defined physical integrity to the anode in particular and to the fuel cell in general. By the same token, nickel per capita values are lower than conventional designs while simultaneously offering excellent conductivity, low CTE properties and high porosity.

While in accordance with the provisions of the statute, there is illustrated and described herein specific embodiments of the invention. Those skilled in the art will understand that changes may be made in the form of the invention covered by the claims and that certain features of the invention may sometimes be used to advantage without a corresponding use of the other features.

1) An anode for a fuel cell, the anode comprising a porous metal substrate for electrical conduction, and a ceramic network for oxygen ion conduction.

2) The anode according to claim 1 wherein the porous metal substrate is selected from the group consisting of nickel foam and nickel felt.

3) The anode according to claim 1 wherein the ceramic network is selected from the group consisting of yttria stabilized zirconia and gadolinium doped cerium oxides.

4) The anode according to claim 1 wherein the ceramic network is a composite including a ceramic component and a metallic component.

5) The anode according to claim 4 wherein the ceramic component is selected from the group consisting of yttria stabilized zirconia and gedolinium doped cerium oxides and the metallic component is selected from the group consisting of nickel and copper.

6) A solid oxide fuel cell, the solid oxide fuel cell comprising a cathode, an anode, and an electrolyte in electrical communication therebetween, the anode including a porous metal substrate having a plurality of interconnected pores, and an oxygen ion conductive ceramic material disposed within the porous metal substrate.

7) The solid oxide fuel cell according to claim 6 wherein the porous metal substrate is selected from the group consisting of nickel foam and nickel felt.

8) The solid oxide fuel cell according to claim 6 wherein the porous metal substrate has a volume fraction of nickel from about 1% to 30% of the anode.

9) The solid oxide fuel cell according to claim 6 wherein the porous metal substrate has a volume fraction of nickel from about 3% to 15% of the anode.

10) The solid oxide fuel cell according to claim 6 wherein the porous metal substrate has a volume fraction of nickel from about 5% to 10% of the anode.

11) The solid oxide fuel cell according to claim 6 wherein the pore size is about 10 μm to 2 mm.

12) The solid oxide fuel cell according to claim 6 wherein the pore size is about 50 μm to 0.5 mm.

13) The solid oxide fuel cell according to claim 6 wherein the porous metal substrate includes nickel selected from the group consisting of nickel powder, nickel particles, and nickel coated graphite.

14) A method for making anodes for solid oxide fuel cells, the method including:
a) providing a porous metal substrate having a plurality of interconnected pores,
b) introducing a carrier containing at least a ceramic material into the substrate, and
c) heating the substrate to form the anode.

15) The method according to claim 14 wherein the porous metal substrate is selected from the group consisting of nickel foam and nickel felt.

16) The method according to claim 14 wherein the metal is selected from the group consisting of nickel and copper.

17) The method according to claim 14 wherein the carrier includes nickel.

18) The method according to claim 14 wherein the carrier includes pore forming agents.

19) The method according to claim 14 wherein the substrate is compressed.

20) The method according to claim 14 wherein the substrate is formed by metal carbonyl plating.

21) The method according to claim 14 wherein the metal porous substrate is formed by a method selected from the group consisting of chemical vapor deposition, electroplating, sputtering, directed vapor deposition and sintering.

22) The method according to claim 14 wherein the anode is disposed in a solid oxide fuel cell.

23) The method according to claim 14 wherein the pore size of substrate is between about 10 μm to 2 mm.

24) The method according to claim 14 wherein the substrate has a volume fraction of the metal from about 1% to 30% of the anode.

25) The method according to claim 14 wherein the coefficient of thermal expansion of the anode is at least similar to the coefficient of thermal expansion of a solid electrolyte disposed within the fuel cell.

26) The method according to claim 14 wherein the substrate is reduced.

27) The method according to claim 14 wherein the carrier is introduced into the substrate as part of a slurry.

28) The method according to claim 14 wherein the ceramic material is selected from the group consisting of yttria stabilized zirconia and gadolinium doped cerium oxides.

29) The method according to claim 14 wherein the carrier includes nickel selected from the group consisting of nickel powder, nickel flakes, nickel fibers and nickel coated graphite.

30) The method according to claim 14 wherein the substrate is sintered.

31) The method according to claim 14 wherein the substrate is simultaneously sintered and reduced.

32) The method according to claim 14 including forming a ceramic network in the anode having a ceramic component and a metallic component.
